(19) United States
(12) Patent Application Publication
(10) Pub. No.: US 2026/0339817 A1
(43) Pub. Date: Oct. 29, 2026

(54) AUTOMATED CLASSIFICATION OF SOFTWARE BEHAVIOR DIFFERENCES USING LARGE LANGUAGE MODELS

(71) Applicant: Microsoft Technology Licensing, LLC, Redmond, WA (US)

(72) Inventors: Jason Edward ENTENMANN, Everett, WA (US); Robert A. DELINE, Seattle, WA (US); Carmen Tatiana BADEA, Sammamish, WA (US); Jade Megan DSOUZA, Seattle, WA (US); Oleg SURMACHEV, Arlington, WA (US); Sandeepan SANYAL, Sammamish, WA (US); Thomas Michael Josef ZIMMERMANN, Newport Beach, CA (US); Christian A. BIRD, Newport Beach, CA (US); Nicole FORSGREN, Tucson, AZ (US); Mikhail DEMYANYUK, Redmond, WA (US); Aliaksandr HRAMADSKI, Bellevue, WA (US); Haris F. MOHAMMAD, Kirkland, WA (US); Denae Ford ROBINSON, Fort Washington, MD (US)

(73) Assignee: Microsoft Technology Licensing, LLC, Redmond, WA (US)

(21) Appl. No.: 19/188,389

(22) Filed: Apr. 24, 2025

(51) Int. Cl. G06F 11/3604; G06F 8/65

(52) U.S. Cl. CPC G06F 11/3604; G06F 8/65

(57) ABSTRACT

This document relates to automated classification of behavior structured differences in release engineering workflows. A computer-implemented method includes receiving a set of behavior structured differences generated from structured differential testing, where each behavior structured difference represents a discrepancy between outputs of a test environment and a production environment for the same real-world input. The method further includes extracting a plurality of attributes from each behavior structured difference, including at least test logs and production logs, and generating an input prompt for a language model (LLM) by structuring the attributes into a textual sequence. The LLM, trained on historical behavior structured differences labeled as noise, new feature, or regression, classifies each behavior structured difference into one of the categories based on the input prompt. The classification is then output to a user interface to support validation of a software update.

### BACKGROUND

Release engineering for large-scale software systems often uses structured differential testing, in which a portion of live production traffic is duplicated and routed to both production and test environments. Telemetry from each environment is compared to identify behavioral discrepancies, known as structured diffs, which include diagnostic metadata such as categories, descriptions, request calls, engineer comments, and environment logs.

These structured diffs must be manually labeled by on-call engineers (OCEs) to determine if they indicate regressions, expected feature changes, or benign differences. Manual labeling is labor-intensive, requires deep system knowledge, and is prone to inconsistency due to fatigue or varying expertise. As system complexity and release frequency grow, the volume of diffs increases, creating a bottleneck that strains deployment workflows and impedes release velocity.

### SUMMARY

This patent relates to the automated classification of software behavior structured differences using large language models. One general aspect includes a computer-implemented method. The computer-implemented method includes receiving, at a computing system, a set of behavior-structured differences generated from structured differential testing, each behavior-structured difference representing a discrepancy between an output of a test environment and an output of a production environment for the same real-world input. The method also includes extracting, by the computing system, a plurality of attributes from each behavior structured difference, the plurality of attributes including at least test logs and production logs.

The method also includes generating, by the computing system, an input prompt for a large language model (LLM) by structuring the plurality of attributes into a textual sequence, where the LLM is based on a training dataset that may include historical behavior structured differences labeled with categories including noise, new feature, and regression.

The method can include fine-tuning the LLM and classifying, using the fine-tuned LLM, each behavior structured difference into categories including noise, new feature, or regression based on the input prompt, where fine-tuning adapts the LLM to identify patterns specific to software behavior structured differences.

The method also includes outputting, by the computing system, the classification for each behavior structured difference to a user interface, where the classification enables validation of a software update. Other implementations of this aspect include corresponding computer systems, apparatus, and computer programs recorded on one or more computer storage devices, each configured to perform the actions of the methods.

Implementations may include one or more of the following features. The method where the plurality of attributes further includes a description of a behavior structured difference. The plurality of attributes further includes calls associated with the behavior structured difference. The plurality of attributes further includes tags identifying or categorizing the behavior structured difference. The plurality of attributes further includes comments from on-call engineers. The method may include dynamically selecting exemplary behavior structured differences from the training dataset based on similarity to each behavior structured difference in a received set. The exemplary behavior structured differences are included in the input prompt for the LLM.

The method may include assigning confidence scores to each classification, the confidence scores indicate reliability in the classification. The confidence scores are generated based on similarity measures between classified behavior structured differences and exemplary behavior structured differences from a fine-tuning dataset. The method may include prioritizing manual review of classifications having confidence scores below a predetermined threshold.

In some instances, the LLM employs a low-rank adaptation (LORA) fine-tuning technique, however, fine-tuning can be omitted in some instances. Implementations of the described techniques may include hardware, a method or process, or computer software on a computer-accessible medium.

One general aspect includes a system having a traffic router configured to duplicate production traffic, sending identical requests to a production server and a test server. The system also includes a production server configured to process production traffic requests and generate telemetry data. The system also includes a test server configured to process duplicated traffic requests and generate telemetry data.

The system also includes a structured difference engine configured to compare telemetry data from the production and test servers, generating behavioral structured differences. The system also includes a structured difference database configured to store generated behavioral structured differences. The system also includes an artificial intelligence processing module configured to classify behavioral structured differences into noise, new feature, or regression. The system also includes an output interface configured to display classified behavioral structured differences. Other implementations of this aspect include corresponding computer systems, apparatus, and computer programs recorded on one or more computer storage devices, each configured to perform the actions of the methods.

Implementations may include one or more of the following features. The system where the artificial intelligence processing module retrieves and structures behavioral structured differences into input prompts for an LLM. The LLM employs a low-rank adaptation (LORA) fine-tuning technique. The artificial intelligence processing module dynamically identifies historical behavioral structured differences based on semantic similarity. The structured difference database stores attributes including logs, call metadata, tags, and comments from on-call engineers. The system may include a feedback mechanism configured to update a fine-tuning dataset based on manual classification corrections. The artificial intelligence processing module assigns confidence scores to each classification. Classifications with confidence scores below a threshold are prioritized for manual review. Implementations of the described techniques may include hardware, a method or process, or computer software on a computer-accessible medium.

Another general aspect includes a computer-implemented method for training a large language model to classify software behavior structured differences. The computer-implemented method also includes receiving, by a computing system, a training dataset may include a plurality of labeled behavior structured differences, each behavior structured difference may include a plurality of attributes including test logs, production logs, a description, and a label selected from a predefined set of classification categories. The method also includes encoding, by the computing system, the plurality of attributes for each behavior structured difference into a serialized textual format. The method also includes applying, by the computing system, a parameter-efficient fine-tuning technique to a pretrained large language model, the parameter-efficient fine-tuning technique configured to update a set of inserted trainable parameters while maintaining pretrained model parameters in a fixed state. The method also includes producing, by the computing system, a fine-tuned large language model adapted to assign a classification category to an unlabeled behavior structured difference based on encoded attributes derived from software telemetry. Other embodiments of this aspect include corresponding computer systems, apparatus, and computer programs recorded on one or more computer storage devices, each configured to perform the actions of the methods.

Implementations may include one or more of the following features. The method where the parameter-efficient fine-tuning technique may include inserting low-rank adaptation matrices into projection layers of the pretrained large language model, and optimizing the inserted matrices using a supervised loss function computed over classification error. The method may include validating the fine-tuned large language model by applying it to a reserved subset of the training dataset and evaluating performance metrics including accuracy, precision, and recall across each classification category. Implementations of the described techniques may include hardware, a method or process, or computer software on a computer-accessible medium.

This Summary is intended to introduce some of the present concepts described in this patent and is not intended to be limiting or all-inclusive of the novel concepts.

### BRIEF DESCRIPTION OF THE DRAWINGS

The Detailed Description is described with reference to the accompanying figures. In the figures, the left-most digit(s) of a reference number identify the figure in which the reference number first appears. The use of similar reference numbers in structured different instances in the description and the figures may indicate similar or identical items.

FIG. 1 illustrates a system architecture for detecting, classifying, and processing behavioral differences between test and production environments in a release engineering workflow.

FIG. 2 provides a high-level process overview of the differential testing and classification pipeline for structured diffs.

FIG. 3 depicts a detailed component architecture for classifying structured diffs using a fine-tuned language model, including a difference engine, a classification engine, and an output storage layer.

FIG. 4 shows a process for selecting static and dynamic few-shot examples to support in-context learning using a large language model.

FIG. 5 outlines an end-to-end workflow for collecting, preparing, training, and evaluating a classification model for structured diffs.

FIG. 6 illustrates a method for triggering automated enforcement actions based on high-confidence regression classifications to prevent deployment of regressive software builds.

FIG. 7 is a flowchart of an example method.

FIG. 8 is a schematic diagram of an example computing architecture.

### DETAILED DESCRIPTION

### Overview

This patent relates to automatic classification of behavior structured differences observed during structured differential testing procedures within software release engineering pipelines. As noted above, structured differential testing is a validation technique employed in deployment workflows to ensure that software modifications do not introduce regressions or performance degradations. This technique operates by duplicating a portion of live production traffic and sending the duplicated requests to both the production and test environments. Telemetry from both environments is then analyzed to detect behavioral discrepancies attributable to the proposed software changes.

Unlike abstract labeling tasks or human classification routines, the disclosed system addresses a technical problem in computing, automating telemetry-based discrepancy classification in a high-throughput release engineering environment. The classification problem addressed here cannot be performed reliably by humans at-scale, due to the volume of log data, structured telemetry, and operational metadata. This constraint necessitates a computer-centric solution that processes telemetry artifacts using machine learning techniques integrated into production infrastructure.

Structured diffs are evaluated prior to production release to assess whether they represent acceptable modifications, newly introduced regressions, or noise resulting from non-deterministic system behavior. In prevailing systems, on-call engineers (OCEs) are responsible for reviewing and labeling each structured diff. This review process requires engineers to analyze telemetry logs, cross-reference system outputs, and often consult institutional (often subjective) knowledge to identify the underlying cause of each observed structured difference. Given the scale of modern deployments, this process can require engineers to evaluate hundreds or thousands of structured diffs within a single release cycle.

The present disclosure provides a technical solution that eliminates the need for manual structured diff classification by introducing an automated labeling component based on a large language model (LLM), which can in some implementations include a fine-tuned LLM. The system ingests structured representations of structured diffs produced by comparing telemetry from test and production environments. Each structured diff is encoded using a set of attributes determined in collaboration with experienced OCEs, including a structured difference category, descriptive metadata, invocation logs, annotation tags, test environment logs, production environment logs, and engineer comments. These attributes are serialized into a structured prompt and provided as input to the LLM classifier.

The LLM classifier is trained on historical data labeled by engineers, enabling it to assign each incoming structured diff to a predefined category aligned with operational policy, such as identifying a structured diff as an expected change, a regression, or an environmental artifact. The output classification is integrated into the deployment orchestration system, allowing subsequent release decisions to be executed programmatically based on the LLM classifier's determination.

The disclosed system also improves the technical operation of computing environments that support software deployment by converting a previously subjective process into a deterministic and repeatable classification operation. The LLM classification architecture incorporates both in-context learning and parameter fine-tuning techniques to adapt the LLM classifier to the specialized domain of structured diff analysis, leveraging textual reasoning capabilities to interpret complex log data.

The system is configured to incorporate feedback from manual engineer review sessions to enhance the model's performance over time. Classification overrides performed by engineers are recorded and used to update the training dataset, enabling model retraining and continual refinement. The inclusion of this feedback mechanism ensures that the model evolves in response to deployment-specific patterns and edge cases.

This technical solution enhances the performance of release engineering infrastructure by enabling more efficient telemetry evaluation, increasing consistency in classification decisions, and reducing reliance on human labor for evaluation tasks. These improvements collectively contribute to accelerating deployment readiness assessments, enabling higher deployment frequency, and increasing the resilience of production systems during change introduction.

These implementations are configured not merely to replicate human judgment, but to solve a computing system performance bottleneck through scalable machine interpretation of diagnostic signals. The system architecture supports integration into telemetry workflows and enables structured decision automation, improving the operation of release engineering infrastructure.

### Example Implementations

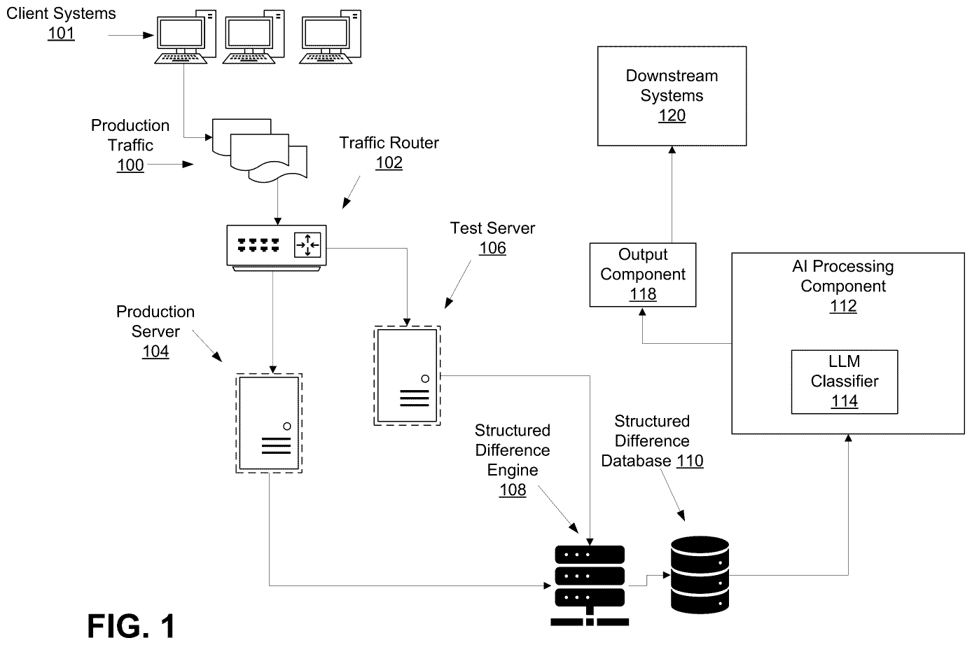

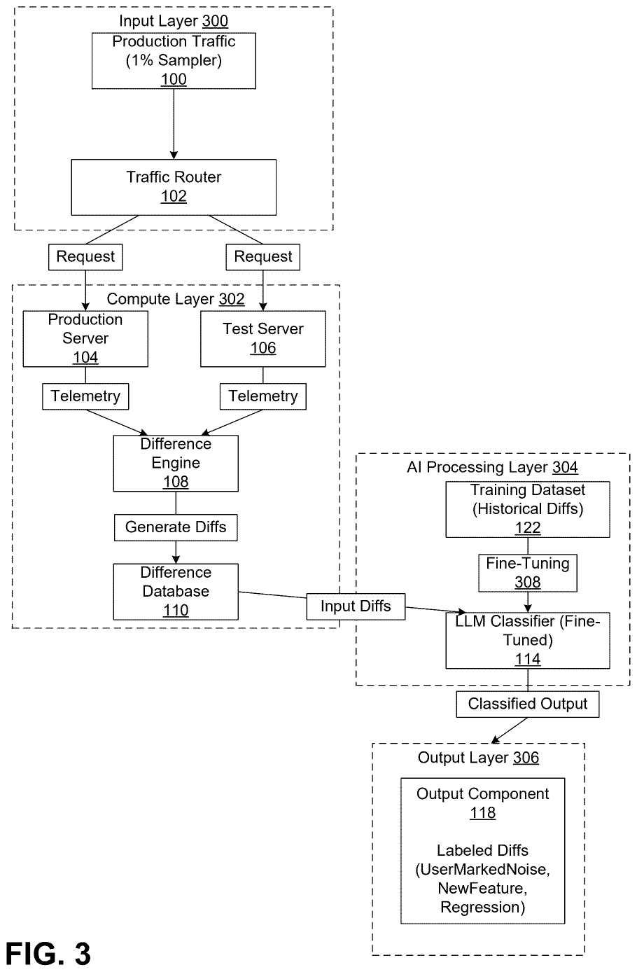

FIG. 1 depicts a system architecture for identifying and classifying behavioral structured differences in a release engineering workflow. The system comprises an input layer, a compute layer, a structured difference analysis stage, an AI processing component, and an output layer; these layers are illustrated in FIG. 3.

Production traffic 100, including live service requests from client systems 101, is sampled at a defined rate, such as one percent, to yield a representative subset for testing. Traffic router 102 is configured to fork each sampled request into two instances. A first instance is routed to production server 104, and a second instance is routed to test server 106.

Production server 104 executes the currently deployed software version and generates telemetry in response to incoming requests. Test server 106 executes a modified or updated version of the software under evaluation and produces the corresponding telemetry based on identical input traffic.

Both production server 104 and test server 106 transmit telemetry to structured difference engine 108. Structured difference engine 108 performs a structured comparison of the telemetry streams to identify behavioral discrepancies between the test and production environments. These discrepancies may include variations in response payloads, status codes, execution timing, logging content, or other observable outputs.

Structured difference engine 108 generates a structured diff for each behavioral discrepancy. A structured diff is a structured data object representing an observed divergence in behavior between the two environments, test and production. Each structured diff is a serialized comparison artifact that may be stored in a structured format, such as JSON, and is suitable for both automated and manual evaluation of functional correctness, regressions, or feature changes.

Each structured diff includes a defined set of attributes that describe the discrepancy, such as diagnostic metadata (including category and description), service call traces, contextual tags, user comments, and logs from both environments. These structured attributes support downstream analysis and enable consistent interpretation. The structured diffs are stored in structured difference database 110, which serves as a persistent repository for behavior structured differences generated during testing. Table 1, provided below, includes example attributes and descriptions for difference labeling.

TABLE 1

| Attribute | Description |
|---|---|
| Category | Describes the type of difference observed between test |
| | and production environments, such as ErrorCode, |
| | MaskedResponse, SigninReport, TokenClaimsBlob, |
| | Result, or Misc. |
| Description | Provides details about the specific difference identified |
| | in the log entries, including diagnostic steps or searches |
| | that can help clarify the nature of the difference. |
| Calls | Lists all the request calls that are associated with the |
| | Diff, helping identify where in the process the |
| | differences occurred. |
| Tags | Contains identifiers and descriptors that label or |
| | categorize the Diff for easy tracking and understanding. |
| Comments | Provides additional context or insights from engineers |
| | or system users about the Diff, often offering |
| | explanations or clues regarding the observed |
| | differences. |
| Test Logs | Contains detailed log entries generated during the test |
| | build, providing information about the behavior and |
| | output of the system during testing. |
| Prod Logs | Contains detailed log entries from the production |
| | environment, showing the actual behavior and output of |
| | the system when deployed live. |
| OCE Insight | Insights gained from interviews with OCEs, which |
| | highlights their process of using categories and |
| | descriptions to compare attributes between test and |
| | prod logs for labeling diffs. |

Structured diffs stored in structured difference database 110 are transmitted to an AI processing component 112. The AI processing component 112 is a classification module configured to apply machine learning models to unlabeled structured diffs and infer their operational significance. The AI processing component 112 includes LLM classifier 114, which comprises a fine-tuned large language model adapted to recognize patterns across software behavior structured differences.

LLM classifier 114 receives structured diffs from structured difference database 110 and classifies each structured diff into one of a set of predefined categories. Each structured diff includes structured input attributes such as test logs, production logs, category fields, and other metadata. The classifier uses patterns learned from a training corpus, referred to as a training dataset of labeled structured diffs to assign an operational label. In one implementation, the label set includes UserMarkedNoise, NewFeature, and Regression.

In one instance, the classifier 114 dynamically identifies exemplar behavior structured differences based on semantic similarity to each received behavior structured difference. The identified exemplar behavior structured differences are included in the input prompt provided to the large language model, in some instances

In one implementation, classification outputs trigger enforcement actions based on label type. For example, if a structured diff is classified as Regression with a high confidence score, the system may automatically revoke associated deployment tokens or block access to release candidate binaries until a manual review occurs. This response framework enables real-time mitigation of regressions before they reach production and is technically analogous to zero-day threat detection in cybersecurity pipelines.

In one example, a structured diff retrieved from the structured difference database includes the attributes category, description, tags, test logs, production logs, and engineer comments. In one instance, the category is “MaskedResponse,” with a description referencing missing keys in a J SON payload. Tags identify the relevant backend service, and the test and production logs show a mismatch in the formatting of a token object. Comments from an on-call engineer note that similar discrepancies have previously been attributed to non-deterministic serialization behavior.

The AI processing component processes this structured diff using a semantic embedding function to convert the attributes into a vector representation. Each diff in the training dataset, which includes labeled structured diffs with categories such as UserMarkedNoise, NewFeature, and Regression, is similarly embedded. The system computes cosine similarity between the test diff and all training examples, identifying the three most similar labeled diffs.

Suppose the top three retrieved training examples are labeled UserMarkedNoise with similarity scores of 0.93 and 0.91, and Regression with a similarity score of 0.75. These values are used to calculate a confidence score for the predicted classification. The classifier aggregates the similarity scores for the most frequent label (UserMarkedNoise) and divides that by the total similarity across the top three examples. This results in a confidence score of 1.84 divided by 2.59, or approximately 0.71.

Because this confidence score is below a predefined threshold of 0.80, the structured diff is flagged for manual review. This flag ensures that potentially ambiguous classifications are reviewed by a human before they influence automated deployment workflows. The system logs the predicted label, the associated confidence score, and the identifiers of the examples used for similarity matching. If the on-call engineer changes the label during the manual review, the correction is stored as feedback for future model training, allowing the LLM to better adapt to similar patterns over time.

The classification results generated by LLM classifier 114 are forwarded to output component 118. Output component 118 is configured to persist labeled structured diffs and interface with downstream systems 120. These systems may include deployment orchestration modules, alerting systems, or validation pipelines. The classification outputs may trigger automated gating logic, regression alerts, or manual review processes, thereby supporting release management and deployment integrity.

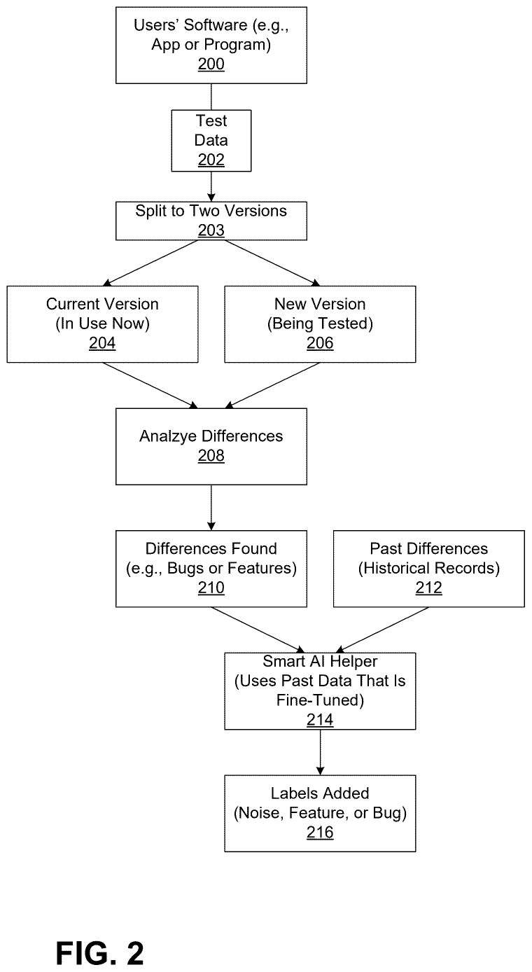

FIG. 2 illustrates a high-level process for classifying behavior structured differences generated during software validation using structured differential testing. The process shown in FIG. 2 is executed by the system of FIG. 1 and provides a functional overview of how new software builds are evaluated and behavior-structured differences are labeled for operational use.

User software 200 represents a deployed software system, such as an application or service executing in a production environment. In preparation for testing, a dataset of incoming requests, referred to as test data 202, is identified and duplicated. The test data may be derived from production inputs or synthetic traffic constructed to emulate production workloads.

The test data is split in step 203 and distributed to two versions of the system. A current version 204 corresponds to the version that is actively running in the production environment. A new version 206 is a test build incorporating proposed code changes or updates that have not yet been released to production.

Both versions execute using the same inputs, and their respective behaviors are analyzed in step 208. A comparison engine or structured difference engine identifies deviations between the observed outputs of the current version 204 and the new version 206. This comparison may consider logs, response payloads, state transitions, and other telemetry signals.

In step 210, the structured differences identified between the two versions are discovered and subsequently stored. These behavior-structured differences, or structured diffs, represent observable divergence in behavior and may correspond to intended features, unintended regressions, or inconsequential noise.

The identified structured differences are processed in conjunction with past structured differences 212, which are historical records of previously labeled structured diffs. These records are used to inform a classification engine about how similar structured differences were handled in prior deployments.

In step 214, a smart AI helper processes the new structured diffs using historical data as a contextual foundation. This AI helper may comprise a fine-tuned large language model or other classifier trained on labeled examples from past on-call engineer sessions.

This architecture improves computer functionality by transforming raw telemetry into structured inference outputs, integrating structured difference processing with machine learning pipelines. The AI processing component does not automate a mental process, it processes structured telemetry artifacts and diagnostic log metadata in a manner that would be infeasible for manual analysis at deployment scale.

The output of the classification process is produced in step 216. Each structured diff is assigned a label corresponding to an operational category, such as noise, new feature, or regression. These labels may then be consumed by release engineering systems to control deployment gating, escalation protocols, or quality assurance workflows.

FIG. 3 illustrates an architecture for detecting, recording, and classifying behavioral differences in a release engineering pipeline using differential testing and machine learning-based inference. The system is organized across an input layer 300, a compute layer 302, an AI processing layer 304, and an output layer 306. Each component performs a specific role in transforming raw production data into structured, labeled outputs used to support automated deployment decisions.

Production traffic 100 represents live service requests received by a software system in operational use. A statistically representative portion of this traffic can be extracted, for example, one percent, so that the system can test new software builds without impacting the primary production path.

Traffic router 102 is configured to fork the sampled production traffic into duplicate requests. A first duplicate is routed to production server 104, and a second duplicate is routed to test server 106. Production server 104 executes the stable version of the deployed software, while test server 106 executes a build containing new or modified features.

Both production server 104 and test server 106 emit telemetry streams in response to their respective requests. These telemetry streams include log data, structured diagnostic outputs, status codes, internal state transitions, and performance metrics. The telemetry is transmitted to the structured difference engine 108.

Structured difference engine 108 performs a structured comparison of the telemetry from production server 104 and test server 106. This comparison is designed to detect structured differences in behavior between the two software versions, regardless of whether the changes were intentional, accidental, or environmental. Each identified structured difference is serialized into a structured data object referred to as a structured diff.

In some implementations, each structured diff contains a set of seven attributes identified through empirical analysis of manual labeling workflows: a category identifier specifying the type of change (e.g., ErrorCode, TokenClaimsBlob), a freeform description, a list of request calls, contextual tags, user or engineer comments, test logs, and production logs. The system optionally computes additional signals, such as “OCE Insight,” derived from pattern-matching and log comparison heuristics observed during on-call engineer sessions.

Generated structured diffs are stored in structured difference database 110, which provides persistent storage for post-processing. Structured difference database 110 is configured to expose stored structured diffs to downstream systems via retrieval interfaces or event-based data transfer protocols.

Fine-tuning component 308 is part of AI processing component 112 and is configured to perform supervised model adaptation using labeled diff data, applying a parameter-efficient tuning technique. During training, the fine-tuning component 308 receives inputs from training dataset 122, which comprises structured diffs annotated with known labels by on-call engineers. Fine-tuning component 308 is operatively coupled to LLM classifier 114 and modifies a subset of the LLM classifier's internal parameters to improve classification performance on diff classification tasks.

LLM classifier 114 improves the technical processing of telemetry data by producing structured, machine-readable classifications that integrate directly with gating and orchestration systems. This result is not simply a human-like judgment, but a computationally derived operational label linked to system behavior.

In one implementation, fine-tuning component 308 employs parameter-efficient tuning methods such as Low-Rank Adaptation (LORA), which introduces additional trainable weights to selected layers of the base language model while keeping the majority of the pre-trained model weights frozen. This approach reduces the computational burden of training while enabling the classifier to adapt to the domain-specific task of labeling behavior differences.

Fine-tuning component 308 operates offline and is invoked prior to the deployment of LLM classifier 114 for inference. The resulting fine-tuned model is then used by the AI processing component 112 to classify newly generated diffs retrieved from structured difference database 110. This training procedure enables the LLM classifier 114 to recognize behavioral patterns that distinguish among operational categories such as UserMarkedNoise, NewFeature, and Regression.

The LLM classifier 114 applies domain-specific learning to complex diagnostic logs and metadata, enabling machine classification of artifacts that lack simple rules. This use of LLMs in structured telemetry environments extends beyond mere information labeling and constitutes a technical improvement to how discrepancies are filtered and acted upon in release engineering.

The LLM classifier 114 receives input structured diffs and maps them to one of several predefined operational categories. In one implementation, the classifier outputs a label selected from UserMarkedNoise, NewFeature, or Regression. These labels correspond to operational behaviors: UserMarkedNoise indicates non-impactful structured differences due to noise or non-determinism; NewFeature indicates expected behavior stemming from newly introduced functionality; and Regression indicates unintentional behavioral changes due to a defect or failure.

Downstream systems may include automated access control mechanisms configured to restrict the propagation of test builds labeled with critical regressions. These systems can deactivate internal deployment channels or issue automated rollback commands if classification confidence for a Regression label exceeds a defined threshold.

Once classified, the labeled structured diffs are provided to output component 118 of the output layer 306. Output component 118 stores the labeled structured diffs in a format consumable by release downstream systems 120 (FIG. 1). These systems may use the classifications to determine whether a build is safe to deploy, requires rollback or needs further manual investigation.

The LLM classifier 114 can be retrained periodically using feedback collected from post-deployment labeling overrides, manual corrections, or new examples. This retraining mechanism allows the model to adapt over time to evolving system behavior, labeling criteria, and operational tolerances, improving its accuracy and utility in future release cycles.

In more detail, to automate the process of labeling behavior structured differences, or structured diffs, as generated by structured difference engine 108, the system implements a classification architecture based on large language models (LLMs). As noted above, the LLM classifier 114, located within AI processing layer 304, is configured to apply two (or more) distinct machine learning techniques to perform classification: in-context learning and fine-tuning.

LLM classifier 114 is constructed using a transformer-based architecture pre-trained on a large corpus of textual data. In one implementation, the model is further adapted to the structured diff classification domain using fine-tuning on training dataset 122, which includes previously labeled structured diffs obtained from on-call engineer review sessions. The fine-tuning process applies domain-specific optimization techniques to update a subset of model parameters without retraining the full base model.

In one implementation, model retraining is performed using a parameter-efficient fine-tuning technique referred to as Low-Rank Adaptation, or LoRA. This technique avoids modifying the complete parameter set of the underlying language model. Instead, LoRA inserts additional trainable matrices into selected linear projection layers within the transformer architecture. These matrices are configured to be low-rank, meaning they contain a significantly reduced number of parameters relative to the original layers. The inserted matrices are optimized to capture task-specific representations relevant to structured diff classification, while the original model weights remain frozen to preserve general language understanding.

This fine-tuning approach enables retraining to occur on a frequent basis using validated diffs that have been labeled or corrected by on-call engineers. Once enough feedback data is accumulated, the system initiates a training process that updates only the LoRA matrices. This selective updating prevents degradation of core model performance and avoids overfitting to short-term operational trends.

During training, the system applies a supervised loss function computed over classification error across all supported label types. Optionally, the training objective may apply class-based weighting or incorporate uncertainty metrics to focus learning on prior misclassifications. The resulting model checkpoint reflects updated classification behavior without requiring computationally expensive retraining of the full base model.

After training is completed, the adapted model is validated on a reserved subset of labeled diffs that were not used in training. Only models that satisfy established performance criteria, such as target thresholds for accuracy, precision, and recall across the Regression class, are eligible for deployment. If the criteria are met, the updated model is versioned and introduced into the active classification pipeline.

This retraining workflow enables continuous improvement of the classification engine with minimal resource overhead. The use of LORA facilitates fast iteration cycles, supports the auditability of model evolution, and improves alignment with current labeling practices and telemetry behavior. As a result, the system remains responsive to operational drift and domain shifts in structured diff characteristics over time.

Alternatively, or additionally, LLM classifier 114 may employ in-context learning, in which a small set of labeled example structured diffs are incorporated into the input prompt as reference context. The classifier uses these examples to infer the appropriate label for an unlabeled structured diff based on similarity in structure, content, and metadata.

To perform labeling, a structured diff is retrieved from the structured difference database 110. The structured diff includes telemetry-based structured differences identified between test server 106 and production server 104, each of which processed identical input requests routed by traffic router 102. The structured diff is serialized to include structured attributes such as structured difference category, request call trace, log outputs, descriptive metadata, and engineer comments. The LLM classifier 114 analyzes these attributes and determines an appropriate classification based on learned patterns or contextual inference.

Each structured diff is assigned one of a defined set of labels, such as UserMarkedNoise, NewFeature, or Regression, and the result is output to output layer 306. This classification enables downstream systems to apply automated decision logic for gating, escalation, or approval of software releases.

### Empirical Testing and Validation

A production-scale release engineering team implemented a structured differential testing workflow to support the evaluation of new software builds against live traffic conditions. Each new build can be deployed to a test environment configured to receive mirrored production traffic. When requests were simultaneously processed by the production environment and the test environment, behavioral structured differences, referred to as structured diffs, were recorded. These structured diffs were manually reviewed and labeled by on-call engineers (OCEs), with each structured diff stored in a structured repository accessible for post-processing.

For each software release, the system generated hundreds of structured diffs. To support structured representation and downstream classification, each structured diff was encoded using seven defined attributes: (1) a category field identifying the nature of the structured difference, (2) a description field containing diagnostic metadata, (3) a list of calls associated with the structured diff, (4) a set of tags used for internal grouping, (5) a comments field capturing contextual input from engineers, (6) test logs representing the behavior of the test build, and (7) production logs representing the behavior of the deployed build. These attributes were identified based on observed OCE labeling practices and were selected for their effectiveness in capturing meaningful features of system behavior during test and production divergence.

In addition to the structured attributes, OCEs rely heavily on domain-specific experience accumulated over time. This experiential knowledge, sometimes referred to as tribal knowledge, influenced labeling outcomes by informing how OCEs interpreted structured differences in log structures, error codes, or contextual signals. An informal analysis of OCE workflows showed that engineers consistently reviewed logs and used a combination of the category and description fields to locate the root cause of each structured diff.

To replicate this process in an automated system, a comparison function was implemented in the AI processing layer 304 to simulate the log review behavior performed by OCEs. This function extracts and compares key metadata from the test and production logs, generates a structured output reflecting this comparison, and appends it to the structured diff as an additional attribute, designated “OCE Insight.” This derived attribute enhances the classifier's input by embedding logic that reflects human decision-making heuristics.

Two datasets were constructed to support the development and evaluation of the classification system. An initial dataset comprising 3,981 (see Table II) labeled structured diffs was collected to support model selection, experimentation, and refinement. Following preliminary analysis, a second, larger dataset was assembled, consisting of 12,683 (see Table III) labeled structured diffs. Each structured diff in both datasets was represented using the same structured attribute schema, and each was labeled manually by OCEs according to standardized operational criteria. These datasets were used to train and validate classification models used within AI processing layer 304, for example.

TABLE II

| | Data Split | | | |
|---|---|---|---|---|
| | Training | Validation | | Total |
| Diff Labels | Set | Set | Test Set | Count |
| UserMarkedNoise | 1,524 | 508 | 509 | 2,541 |
| NewFeature | 823 | 274 | 275 | 1,372 |
| Regression | 41 | 14 | 13 | 68 |
| Total Diffs | 2,388 | 796 | 797 | 3,981 |

TABLE III

| | Data Split | | | |
|---|---|---|---|---|
| | Training | Validation | | Total |
| Diff Labels | Set | Set | Test Set | Count |
| UserMarkedNoise | 7,909 | 795 | 1,483 | 9,887 |
| NewFeature | 1,981 | 124 | 372 | 2,477 |
| Regression | 255 | 16 | 48 | 319 |
| Total Diffs | 10,145 | 635 | 1,903 | 12,683 |

Each dataset was partitioned into training, validation, and test subsets in accordance with standard practices in supervised machine learning. The training subset was used to fit the classification model parameters, the validation subset was used to monitor the model's performance during training and to tune hyperparameters to mitigate overfitting, and the test subset was used to evaluate model performance on unseen data. Tables II and III contain the label distributions for each subset.

The label taxonomy applied across all datasets included three primary categories: UserMarkedNoise, NewFeature, and Regression. Analysis of the data revealed that the most frequent label was UserMarkedNoise, followed by NewFeature and then Regression. This distribution was confirmed through consultation with on-call engineers (OCEs), who reported that most structured diffs encountered during production validation fall into the UserMarkedNoise category. This alignment between empirical label frequencies and domain expert expectations provided an external consistency check for the dataset composition.

Following dataset construction and attribute encoding, two primary machine-learning methods were investigated for use in the classification system: in-context learning and fine-tuning. Both methods were applied to large language models used within the classification architecture of AI processing layer 304. In the in-context learning configuration, a small number of labeled examples were embedded directly into the input prompt to guide the model's inference on new, unlabeled structured diffs. In the fine-tuning configuration, the model's internal parameters were updated using labeled training data to optimize performance on the structured diff classification task. Both approaches were evaluated for accuracy, consistency, and alignment with historical human-labeled outcomes. One approach implemented within the classification framework of AI processing layer 304 involves the use of in-context learning to assign labels to behavior-structured differences. In this configuration, LLM classifier 114 operates in inference-only mode, relying on a fixed pre-trained model without updating model parameters. Label prediction is guided by a prompt containing examples known as few-shot examples, which are inserted directly into the input alongside the target structured diff. In one embodiment, the AI training lay can use a parameter-efficient tuning technique that inserts additional trainable matrices into selected layers of a model architecture while maintaining a portion of pretrained parameters in a fixed state.

To support this approach, three example structured diffs were selected as in-context examples, each corresponding to one of the three available classification labels: one example labeled as Regression, one as NewFeature, and one as UserMarkedNoise. For each example, both the input (structured representation of the structured diff) and the output (assigned label) were included in the prompt. The test structured diff was then appended to the prompt, and LLM classifier 114 was instructed to return one of the predefined labels based on patterns inferred from the examples.

This method was applied using a state-of-the-art large language model configured for in-context inference. Given the impact of example selection on model performance, two strategies were employed to retrieve few-shot examples: static retrieval and dynamic retrieval.

Under the static retrieval method, a fixed set of examples was selected once from the training dataset and used for all test inferences. For each label category, the first observed occurrence of a structured diff associated with that label was selected. These static examples remained constant across all test structured diff prompts. The objective of this strategy was to assess the baseline performance of the model when using consistent prompt context for all inference operations.

In contrast, dynamic retrieval assigned unique few-shot examples to each test structured diff based on semantic similarity. Both the test structured diff and all training structured diffs were embedded into a continuous vector space using a pre-trained embedding model. Embeddings capture structural and semantic relationships between elements, enabling similarity comparisons. Cosine similarity was computed between the test structured diff and all candidate training structured diffs to identify the three most similar examples, one from each classification label. These selected examples were included in the prompt to tailor the context for each test instance. This method aims to improve classification accuracy by aligning the few-shot context more closely with the content and structure of each test structured diff.

In both retrieval configurations, in-context learning was used without modifying the underlying weights of the LLM. The LLM classifier 114 inferred the appropriate label for each structured diff by reasoning over the in-prompt examples, emulating the manual evaluation patterns performed by on-call engineers.

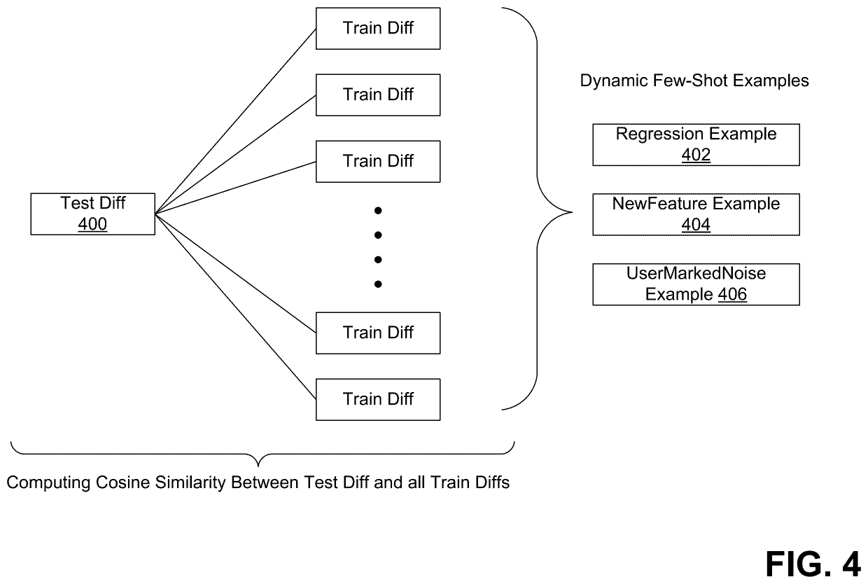

FIG. 4 illustrates a process for generating dynamic few-shot examples used in in-context learning during the structured diff classification workflow. This figure corresponds to the dynamic retrieval configuration discussed in connection with LLM classifier 114 of FIGS. 1 and 3.

A structured test diff 400 is prepared for classification. To support dynamic prompt construction, a similarity computation is performed between structured test diff 400 and each of the structured diffs in the training dataset. Each training structured diff is embedded into a vector space using a pre-trained embedding model, and the same embedding process is applied to structured test diff 400. Cosine similarity is computed between the vector representation of the structured test diff 400 and each training structured diff to measure semantic closeness.

The most similar training structured diffs are identified based on the similarity scores. From this pool of closest matches, one structured diff from each label category is selected to serve as a dynamic few-shot example. Specifically, the system retrieves the nearest training structured diff labeled as Regression 402, the nearest training structured diff labeled as NewFeature 404, and the nearest training structured diff labeled as UserMarkedNoise 406. These selected examples are inserted into the prompt along with the structured test diff 400 and supplied to the classifier.

This method enables each test structured diff to be evaluated using a prompt that is tailored to its specific content and structure, increasing the classification accuracy of the in-context learning method. The dynamic few-shot example generation process ensures that examples are contextually relevant to the test instance, as opposed to using static examples that may not reflect the characteristics of the current input.

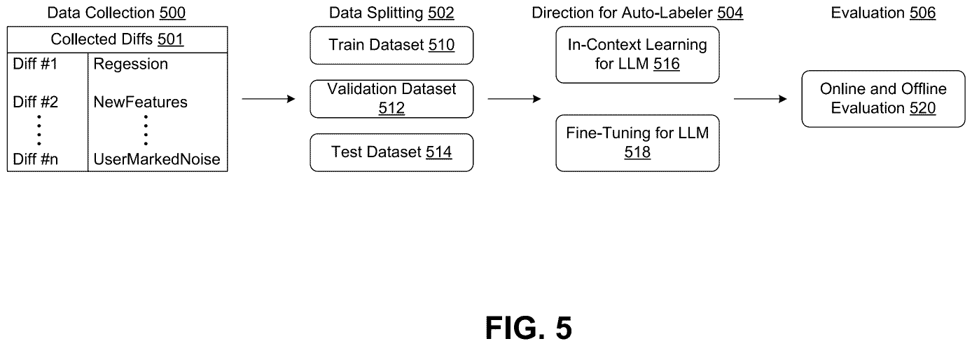

FIG. 5 illustrates an end-to-end workflow for preparing, training, and evaluating a machine learning-based system configured to automatically classify structured behavioral differences, or structured diffs, within a release engineering environment. The illustrated process comprises four distinct phases: data collection 500, data splitting 502, direction for auto-labeler 504, and evaluation 506.

In data collection phase 500, a corpus of structured diffs, referred to as collected diffs 501, is retrieved from a diff generation pipeline. Each structured diff represents a behavioral discrepancy identified between test and production environments and is formatted to include diagnostic attributes such as category, description, service call traces, tags, user comments, test logs, and production logs. Structured diffs are further annotated by on-call engineers (OCEs) with ground-truth labels selected from an operational classification set including UserMarkedNoise, NewFeature, and Regression.

In data splitting phase 502, the collected structured diffs are partitioned into three subsets: a training dataset 510, a validation dataset 512, and a test dataset 514. Training dataset 510 is used to fit or fine-tune the model, validation dataset 512 is used to monitor training progress and mitigate overfitting, and test dataset 514 is reserved for final evaluation to assess generalization.

The auto-labeler phase 504 includes two distinct paths for implementing a structured diff classification system: in-context learning module 516 and fine-tuning component 518. The in-context learning module 516 uses a pre-trained large language model and augments the input prompt with a limited set of labeled example diffs to predict the label of a new diff without altering the model's internal parameters. This path emphasizes inference through contextual guidance alone.

Fine-tuning component 518 enables supervised adaptation of the language model using training dataset 510. Fine-tuning may be performed using parameter-efficient techniques such as Low-Rank Adaptation (LORA), where only select parameters of the model are updated. Fine-tuning component 518 modifies the LLM classifier to align model behavior with the structured diff classification domain.

Evaluation phase 506 measures the model's performance using both offline and online evaluation 520. Offline evaluation assesses the model's predictions against ground-truth labels from test dataset 514 using metrics such as accuracy, precision, recall, and confusion matrices. Online evaluation integrates the classifier into a live labeling workflow, where it is applied to currently structured diffs before manual labels are assigned. The predictions are then compared against finalized OCE labels to assess real-time operational performance.

To complement the aggregate evaluation, accuracy was computed separately for each classification category. Label-specific accuracy was determined using the following expressions 1-4:

$$Accuracy = \frac{TP\_NF + TP\_UN + TP\_R}{TP\_NF + FN\_NF + TP\_UN + FN\_UN + TP\_R + FN\_R} \qquad ( 1 )$$

$${Accuracy}_{NF} = \frac{{TP}_{NF}}{{TP}_{NF} + {FN}_{NF}} \qquad ( 2 )$$

$${Accuracy}_{UN} = \frac{{TP}_{UN}}{{TP}_{UN} + {FN}_{UN}} \qquad ( 3 )$$

$$Accuracy\_R = \frac{TP\_R}{TP\_R + FN\_R} \qquad ( 4 )$$

These label-specific accuracy metrics follow a structure like recall in information retrieval tasks and are used to measure the model's effectiveness in identifying true positive cases for each individual label class. This approach helps to diagnose model behavior in cases where performance may vary across label types and ensures that reliability is maintained across all categories relevant to deployment validation.

Offline evaluation was conducted to assess the performance of various model configurations using previously labeled structured diffs collected from release engineering workflows. These experiments were conducted on the datasets described earlier, beginning with an initial set of 3,981 labeled structured diffs (see Table II). This evaluation focused on in-context learning and fine-tuning techniques applied to multiple language model variants and aimed to determine their suitability for deployment as an automated structured diff labeler capable of supporting on-call engineers (OCEs).

In the first stage, static few-shot examples were evaluated using the in-context learning approach. A fixed set of three labeled structured diffs—each corresponding to one of the classification categories (UserMarkedNoise, NewFeature, and Regression)—was used across the entire test dataset. As shown in Table IV, this configuration resulted in an overall accuracy of 50.19%. Label-specific accuracies were approximately 41% for UserMarkedNoise, 54% for NewFeature, and 61% for Regression. These values suggest that static example selection provides only moderate performance and may not sufficiently align with the characteristics of individual test structured diffs, limiting its practical utility.

TABLE IV

| Metric | Accuracy (%) | Correct/Total |
|---|---|---|
| Total Accuracy | 50.19% | 400/797 |
| NewFeature Accuracy | 41.09% | 113/275 |
| UserMarkedNoise Accuracy | 54.81% | 279/509 |
| Regression Accuracy | 61.54% | 8/13 |

To improve classification accuracy, dynamic retrieval of few-shot examples was introduced, as described in relation to FIG. 4. In this configuration, examples were selected based on cosine similarity to the test structured diff, enabling more contextually relevant prompt construction. Table V presents the results of this approach, which yielded an overall accuracy of 71.27%. The label-specific accuracies were 72% for UserMarkedNoise, 69% for NewFeature, and 69% for Regression. This dynamic in-context learning configuration improved performance by approximately 20 percentage points across all labels relative to the static example baseline. However, although this approach demonstrated measurable gains, accuracy levels in the 60-70% range were insufficient to support the reliability standards required for operational use by OCEs.

TABLE V

| Metric | Accuracy (%) | Correct/Total |
|---|---|---|
| Total Accuracy | 71.27% | 568/797 |
| NewFeature Accuracy | 69.45% | 191/275 |
| UserMarkedNoise Accuracy | 72.30% | 368/509 |
| Regression Accuracy | 69.23% | 9/13 |

To address the limitations of in-context learning and to leverage the full training dataset, fine-tuning experiments were conducted. The initial fine-tuning was performed using the GPT-3.5 architecture, which was selected for its cost efficiency and reduced training duration. As shown in Table VI, the fine-tuned GPT-3.5 model achieved an overall accuracy of 91.5%, with UserMarkedNoise and NewFeature reaching 95% and 89% accuracy, respectively. However, Regression accuracy was 0%. Analysis of the training dataset revealed that only 41 examples of Regression were available in the initial dataset, limiting the model's ability to generalize for that category. While GPT-3.5 performed well on the majority of labels, its limited capacity to learn from sparse samples rendered it unsuitable for the most critical label class.

TABLE VI

| Metric | Accuracy (%) | Correct/Total |
|---|---|---|
| Total Accuracy | 91.47% | 729/797 |
| NewFeature Accuracy | 89.09% | 245/275 |
| UserMarkedNoise Accuracy | 95.09% | 484/509 |
| Regression Accuracy | 0.00% | 0/13 |

To improve performance on Regression and evaluate the impact of model capacity, a GPT-4 model was fine-tuned on the same dataset. Table VII reports the results, which include an overall accuracy of 95%, with label-specific accuracies of 96% for UserMarkedNoise, 95% for NewFeature, and 53% for Regression. The increase in Regression accuracy, despite the small number of training samples, suggests that the model's scale and architecture were able to learn more robust patterns from limited data.

TABLE VII

| Metric | Accuracy (%) | Correct/Total |
|---|---|---|
| Total Accuracy | 95.48% | 761/797 |
| NewFeature Accuracy | 95.27% | 262/275 |
| UserMarkedNoise Accuracy | 96.66% | 492/509 |
| Regression Accuracy | 53.85% | 7/13 |

To further enhance classifier performance, particularly for the Regression category, a larger dataset was assembled. The updated dataset, shown in Table III, included approximately 13,000 structured diffs, tripling the size of the original collection. The number of Regression examples in the training set increased from 41 to 255. This expansion allowed for broader generalization and improved training coverage across all label types.

A new instance of the GPT-4 model was fine-tuned from scratch using this expanded dataset, following the same methodology and training procedures described previously. The goal of this updated fine-tuning cycle was to establish a model that could achieve high reliability across all labels, including Regression, and thus support end-to-end automation of the structured diff labeling task in production deployment environments.

The performance of the structured diff classification system, implemented via LLM classifier 114 of FIG. 3 and structured in the workflow of FIG. 5, was evaluated through a combination of offline and online experiments. These evaluations were designed to assess both predictive accuracy and practical viability in release engineering workflows.

Initial offline experiments were conducted on a dataset of 3,981 manually labeled structured diffs. In-context learning methods were first evaluated using static few-shot examples. As detailed in Table IV, this approach produced an overall accuracy of 50.19%, with class-specific accuracies of 41% for UserMarkedNoise, 54% for NewFeature, and 61% for Regression. These results indicate that using a fixed set of prompt examples for all test structured diffs led to insufficient contextual alignment and limited generalization, rendering the approach impractical for deployment.

To address the insufficient representation of Regression examples, the dataset was expanded to include nearly 13,000 labeled structured diffs. Regression samples in the training set increased from 41 to 255. A new instance of GPT-4 was fine-tuned from scratch on this enlarged dataset. As shown in Table VIII, the updated model achieved an overall accuracy of 97.38%, with 98.18% accuracy for UserMarkedNoise, 96.27% for NewFeature, and 81.25% for Regression.

Precision and recall were also computed to provide deeper insight into the classifier's reliability. For UserMarkedNoise, precision was 0.9885 and recall was 0.9818, indicating high precision and coverage. For NewFeature, precision and recall reached 0.9475 and 0.9627, respectively. Regression, while improved, showed lower precision at 0.75 and recall at 0.8125, revealing an increased tendency for false positives in this class. The confusion matrix showed 13 false positives and 9 false negatives for Regression. These findings demonstrate that the model performs strongly on high-frequency labels and reasonably on Regression, with further improvement possible through increased data balancing and refinement.

TABLE VIII

| Metric | NewFeature | UserMarkedNoise | Regression | Total |
|---|---|---|---|---|
| Accuracy (%) | 96.27% | 98.18% | 81.25% | 97.38% |
| Correct | 361 | 1460 | 39 | 1860 |
| Predictions | | | | |
| Ground Truth | 375 | 1487 | 48 | 1910 |
| Count | | | | |
| True Positives | 361 | 1460 | 39 | — |
| (TP) | | | | |
| True Negatives | 55 | 6 | 1849 | — |
| (TN) | | | | |
| False Positives | 20 | 17 | 13 | — |
| (FP) | | | | |
| False Negatives | 14 | 27 | 9 | — |
| (FN) | | | | |
| Precision | 0.9275 | 0.9885 | 0.75 | — |
| Recall | 0.9627 | 0.9818 | 0.8125 | — |

Following promising offline performance, the fine-tuned GPT-4 model was tested in live deployment conditions. Online evaluation was conducted over a four-week period using real-time structured diff snapshots from the release workflow. Each snapshot contained structured diffs requiring manual labeling by OCEs during on-call sessions. The model labeled the structured diffs independently, and predictions were compared to the ground truth labels published by the OCEs after manual review.

As reported in Tables IX through XII, overall accuracy across all snapshots exceeded 86%. In Snapshots #1 and #3, Regression accuracy was marked as not defined due to the absence of Regression examples, precluding metric computation. UserMarkedNoise accuracy remained consistently above 90% across all snapshots, indicating the model's strong capability to automate noise classification. NewFeature accuracy exceeded 90% in two snapshots and remained above 80% in the others, reflecting reliable model performance in this category under real-world conditions.

TABLE IX

| Metric | NewFeature | UserMarkedNoise | Regression | Total |
|---|---|---|---|---|
| Accuracy (%) | 84.21% | 91.30% | N.D. | 89.23% |
| Correct | 16 | 42 | 0 | 58 |
| Predictions | | | | |
| Ground Truth | 19 | 46 | 0 | 65 |
| Count | | | | |
| True Positives | 16 | 42 | 0 | — |
| (TP) | | | | |
| True Negatives | 0 | 0 | 65 | — |
| (TN) | | | | |
| False Positives | 4 | 3 | 0 | — |
| (FP) | | | | |
| False Negatives | 3 | 4 | 0 | — |
| (FN) | | | | |
| Precision | 0.8 | 0.9333 | N.D. | — |
| Recall | 0.8421 | 0.913 | N.D. | — |

TABLE X

| Metric | NewFeature | UserMarkedNoise | Regression | Total |
|---|---|---|---|---|
| Accuracy (%) | 80.0% | 91.18% | 66.67% | 86.67% |
| Correct | 4 | 31 | 4 | 39 |
| Predictions | | | | |
| Ground Truth | 5 | 34 | 6 | 45 |
| Count | | | | |
| True Positives | 4 | 31 | 4 | — |
| (TP) | | | | |
| True Negatives | 4 | 2 | 39 | — |
| (TN) | | | | |
| False Positives | 5 | 1 | 0 | — |
| (FP) | | | | |
| False Negatives | 1 | 3 | 2 | — |
| (FN) | | | | |
| Precision | 0.4444 | 0.9688 | 1.0 | — |
| Recall | 0.8 | 0.9118 | 0.6667 | — |

TABLE XI

| Metric | NewFeature | UserMarkedNoise | Regression | Total |
|---|---|---|---|---|
| Accuracy (%) | 90.0% | 91.89% | N.D. | 91.23% |
| Correct | 18 | 34 | 0 | 52 |
| Predictions | | | | |
| Ground Truth | 20 | 37 | 0 | 57 |
| Count | | | | |
| True Positives | 18 | 34 | 0 | — |
| (TP) | | | | |
| True Negatives | 0 | 0 | 57 | — |
| (TN) | | | | |
| False Positives | 3 | 2 | 0 | — |
| (FP) | | | | |
| False Negatives | 2 | 3 | 0 | — |
| (FN) | | | | |
| Precision | 0.8571 | 0.9444 | N.D. | — |
| Recall | 0.9 | 0.9189 | N.D. | — |

TABLE XII

| Metric | NewFeature | UserMarkedNoise | Regression | Total |
|---|---|---|---|---|
| Accuracy (%) | 95.65% | 91.89% | 0.0% | 91.8% |
| Correct | 22 | 34 | 0 | 56 |
| Predictions | | | | |
| Ground Truth | 23 | 37 | 1 | 61 |
| Count | | | | |
| True Positives | 22 | 34 | 0 | — |
| (TP) | | | | |
| True Negatives | 1 | 1 | 59 | — |
| (TN) | | | | |
| False Positives | 3 | 1 | 1 | — |
| (FP) | | | | |
| False Negatives | 1 | 3 | 1 | — |
| (FN) | | | | |
| Precision | 0.88 | 0.9714 | 0.0 | — |
| Recall | 0.9565 | 0.9189 | 0.0 | — |

For Regression, accuracy values hovered around 67% in snapshots where the label was present. While this is a marked improvement over earlier baselines, OCEs expressed a preference to manually verify Regression predictions due to the importance of such structured diffs. Nonetheless, the availability of a model-generated initial prediction was viewed as beneficial in reducing the cognitive load and manual inspection time during on-call sessions.

Precision and recall values further support model robustness in live conditions. In Snapshot #4, NewFeature achieved a precision of 0.88 and recall of 0.9565, and UserMarkedNoise achieved a precision of 0.9714. These metrics confirm high prediction quality and minimally false positive rates for the dominant label classes. Regression exhibited reduced performance in snapshots with limited true positives, emphasizing the continued need for manual validation in that category.

Overall, the online evaluation confirmed that the fine-tuned GPT-4 model can support high-confidence classification for UserMarkedNoise and NewFeature, while providing valuable assistance for Regression, subject to manual oversight. These findings validate the system's potential to enhance OCE productivity by serving as a semi-automated assistant in structured diff triage workflows.

To assess the impact of individual input features on model performance, an ablation analysis was conducted on the fine-tuned GPT-4 classifier trained on the expanded dataset described in relation to FIG. 5. The baseline configuration of LLM classifier 114 used seven structured attributes to represent each structured diff, including category, description, calls, tags, test logs, production logs, and comments. Among these, the comments field was observed to contain valuable contextual annotations provided by on-call engineers (OCEs), often used during manual review to explain or clarify the behavior observed in the structured diff.

To quantify the importance of the comments attribute, a new GPT-4 model was fine-tuned using the same training dataset, but with the comments field excluded from the input representation. This allowed for a direct comparison against the fully featured model described earlier. The modified model was evaluated in both offline and online contexts to isolate the effect of removing the comments attribute.

In the offline evaluation, as summarized in Table XIII, model performance declined across all label classes compared to the results in Table VIII, where the full attribute set was used. Nevertheless, the UserMarkedNoise label retained high accuracy, precision, and recall. Specifically, UserMarkedNoise achieved 0.9399 precision and 0.9778 recall, suggesting the model maintained a strong ability to identify and correctly classify noise-related structured diffs even without engineer commentary.

TABLE XIII

| Metric | NewFeature | UserMarkedNoise | Regression | Total |
|---|---|---|---|---|
| Accuracy (%) | 76.53% | 97.78% | 66.67% | 92.83% |
| Correct | 287 | 1454 | 32 | 1773 |
| Predictions | | | | |
| Ground Truth | 375 | 1487 | 48 | 1910 |
| Count | | | | |
| Precision | 0.9025 | 0.9399 | 0.7273 | — |
| Recall | 0.7653 | 0.9778 | 0.6667 | — |

For NewFeature, the model without comments produced a precision of 0.9025 and a recall of 0.7653, indicating a reduction in its ability to capture all relevant instances. Regression classification experienced the most significant decline, with precision at 0.7273 and recall at 0.6667. These values show that without the comments field, the model's ability to infer the underlying behavioral structured difference was diminished, particularly for structured diffs that require deeper interpretability and judgment, characteristics often found in Regression cases.

Online evaluation was conducted using two recent structured diff snapshots generated during live on-call sessions. As shown in Tables XIV and XV, structured diffs in these snapshots were labeled using the fine-tuned GPT-4 model trained without access to the comments attribute. In both snapshots, classification performance for NewFeature dropped sharply, with accuracy ranging from 50% to 60%. In contrast, the UserMarkedNoise label retained high performance, with classification accuracy between 90% and 98%.

TABLE XIV

| Metric | NewFeature | UserMarkedNoise | Regression | Total |
|---|---|---|---|---|
| Accuracy (%) | 60.0% | 97.06% | 0.0% | 80.0% |
| Correct | 3 | 33 | 0 | 36 |
| Predictions | | | | |
| Ground Truth | 5 | 34 | 6 | 45 |
| Count | | | | |
| Precision | 0.6 | 0.825 | 0.0 | — |
| Recall | 0.6 | 0.9706 | 0.0 | — |

TABLE XV

| Metric | NewFeature | UserMarkedNoise | Regression | Total |
|---|---|---|---|---|
| Accuracy (%) | 56.52% | 91.89% | 0.0% | 77.05% |
| Correct | 13 | 34 | 0 | 47 |
| Predictions | | | | |
| Ground Truth | 23 | 37 | 1 | 61 |
| Count | | | | |
| Precision | 0.8125 | 0.7556 | 0.0 | — |
| Recall | 0.5652 | 0.9189 | 0.0 | — |

Regression classification performance was notably impacted. In Snapshot #2, the model failed to correctly identify any of the six Regression-labeled structured diffs, while the full-featured model, including the comments attribute, had successfully identified four out of six. This outcome highlights a substantial dependency on the comments field for reliable regression detection, particularly under live operational conditions.

These results demonstrate that while the model maintains robustness for the UserMarkedNoise category without comments, it suffers measurable degradation in classifying NewFeature and Regression structured diffs. The loss of engineer-provided commentary removes critical semantic context used by the model to distinguish subtle structured differences in behavior. Accordingly, the ablation analysis confirms that the comments attribute contributes materially to model accuracy and consistency, particularly for high-impact structured diff types, and should be retained in production deployments where reliability and explainability are required by OCEs.

The evaluation results demonstrate that leveraging the reasoning capabilities of large language models enables high-performance classification of behavior-structured differences in release engineering workflows. As implemented through LLM classifier 114 and validated across the structured methodology shown in FIG. 5, the automated labeling system achieves classification accuracy levels sufficient to support operational integration and meaningful reductions in manual workload for on-call engineers (OCEs).

The classification task addressed by the disclosed system represents a high-frequency, high-effort responsibility within release workflows. OCEs regularly review and label hundreds of structured diffs per release cycle, requiring substantial time and cognitive effort. The goal of the automated labeling system is to reduce the time spent performing this task, improve consistency, and allow engineers to focus on higher-order responsibilities. The evaluation focused not only on accuracy metrics but also on the practical impact of integrating the system into an active deployment environment.

Prior to automation, OCEs typically required several hours each week to review and label structured diffs manually. Following the deployment of the automated system, the time required to process a snapshot of structured diffs has been reduced to approximately 15 minutes. This time reduction represents a substantial operational improvement and directly alleviates a known bottleneck in release validation workflows.

The use of model-generated labels as initial predictions allows OCEs to quickly accept, verify, or override the suggestions with reduced review effort. This enhances decision efficiency while preserving human oversight, particularly in cases such as Regression structured diffs, where operational risk requires careful validation. Over time, as model performance continues to improve through retraining and feedback, reliance on manual validation may decrease further.

The broader impact of this integration extends to release cadence and developer productivity. By streamlining the structured diff triage process, teams can release software more rapidly and with greater confidence. This reduces friction in the continuous deployment pipeline, supports faster delivery of new features, and contributes to improved engineering morale by reducing repetitive manual tasks. The system thereby delivers technical and organizational value through both direct labor reduction and enhanced throughput in software delivery operations.

The fine-tuned GPT-4 model exhibited strong performance in the structured diff classification task, achieving high levels of accuracy across all evaluated scenarios. While traditional machine learning methods such as decision trees and neural networks have historically been employed for classification problems, these approaches typically require large volumes of well-structured feature data. In contrast, the structured diff labeling task is characterized by features that are primarily unstructured and textual, including engineer comments, logs, and descriptive annotations.

Due to the text-heavy nature of the input data, the use of large language models (LLMs) was particularly well suited to the problem domain. LLMs are trained on extensive text corpora and demonstrate strong capabilities in both understanding and generating natural language. The decision to adopt an LLM-based approach was guided by the richness of the textual information present in the structured diffs and the models' capacity to extract and reason over complex language patterns. As demonstrated in the results, prompting and fine-tuning LLMs allowed the system to perform well even on nuanced and high-judgment tasks such as Regression labeling.

The classification task itself is central to machine learning and has been the focus of substantial research. Based on the experimental results obtained in this work, it was confirmed that LLMs can reliably be applied to classification problems that involve structured and semi-structured textual inputs. Traditional models often require significant preprocessing or feature engineering to handle such data. In contrast, LLMs already possess generalized textual reasoning capabilities that can be rapidly adapted to new domains with relatively modest volumes of training data.

Experiments also confirmed that model size has a significant impact on performance. Initial fine-tuning with GPT-3.5 showed promising results for high-frequency labels but struggled with low-frequency classes such as Regression. In contrast, the GPT-4 model, with an order of magnitude more capacity, was able to better generalize from sparse training examples and achieve significantly improved accuracy across all label classes. The performance gains observed suggest that model scale correlates positively with robustness and label generalization.

Further, the results demonstrate that LLMs remain effective even when training data is limited. Whereas traditional models typically require large datasets to avoid underfitting, LLMs can leverage prior knowledge from pretraining to perform well in low-data regimes. This characteristic is particularly valuable in release engineering contexts, where labeled data may be structured as difficult or expensive to collect at scale.

This disclosure describes a system for automating the labeling of behavior-structured differences in release engineering using fine-tuned large language models. The system demonstrates high accuracy in both offline and online evaluations and can classify structured diffs into operationally meaningful categories: UserMarkedNoise, NewFeature, and Regression.

The current system provides high-accuracy label predictions that support OCE workflows. However, model integration can be further enhanced by transitioning from a pure classifier to an assistant-style architecture. In such a system, each predicted label would be accompanied by an explanation or justification. This would allow OCEs to validate predictions more efficiently and build trust in the model's outputs.

Finally, while the system was initially developed for use within a specific release engineering team, the underlying architecture is generalizable to other teams and domains. Given the widespread use of structured differential testing across production software organizations, including within other divisions, the approach outlined here may be scaled and adapted to support automated structured diff labeling at an enterprise scale. The demonstrated gains in classification accuracy, reduction in manual effort, and improvements in developer efficiency highlight the broader value of integrating LLM-based automation into core software engineering workflows.

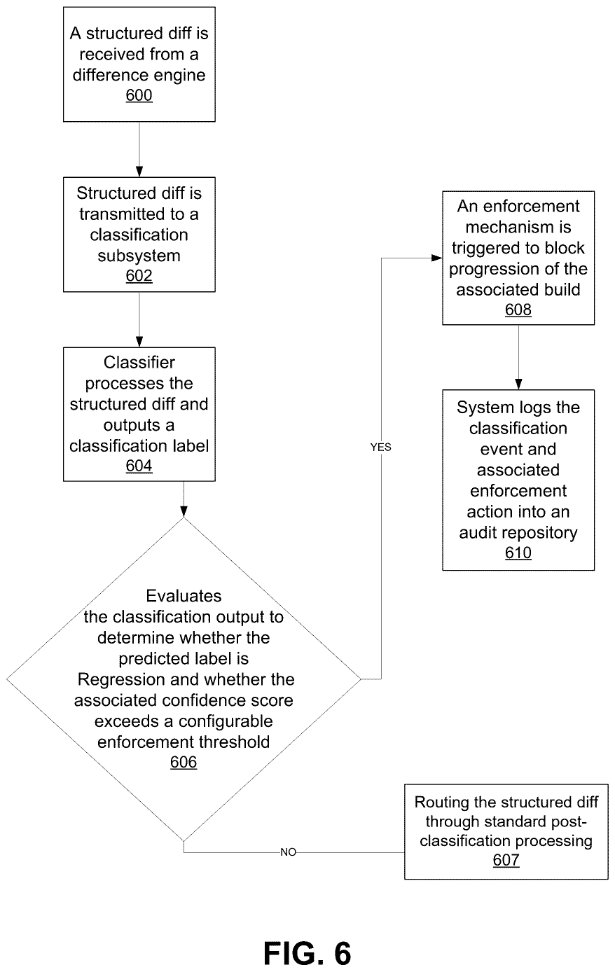

FIG. 6 illustrates a method for enforcing release safety controls by integrating machine-learned classification outputs into automated gating and operational workflows. The method enables structured decision-making based on telemetry-driven discrepancy analysis to prevent the deployment of regressive or destabilizing software updates.

The method begins at step 600, where a structured diff is received from a difference engine. The structured diff represents an observed behavioral divergence between a test instance and a production instance of a software service. Each structured diff includes a predefined set of attributes, such as request payloads, test logs, production logs, service call traces, category fields, user-entered comments, and tags. Additional metadata may be extracted from logs using pattern-based analysis functions.

At step 602, the structured diff is passed to a classification engine. The classification engine includes a fine-tuned language model trained to label behavior differences using historical examples. The classifier consumes structured attributes of the diff and produces an operational label based on learned domain-specific patterns.

At step 604, the classifier generates a classification label, such as Regression, NewFeature, or UserMarkedNoise. It also generates a confidence score, representing a normalized probability or scalar value indicating the certainty of the predicted label.

In one implementation, the classifier generates a confidence score by first computing raw output values known as logits for each label class supported by the system. These logits are derived from the final projection layer of the language model and represent unnormalized estimates of the relevance of each label to the input structured diff. To convert these values into interpretable probabilities, the system applies a softmax transformation, which exponentiates each logit and then normalizes it by the sum of all exponentiated logits.

For example, if the classifier produces logits of 2.3 for the Regression class, 1.2 for NewFeature, and 0.5 for UserMarkedNoise, the system first computes the exponentials of each value. The exponential of 2.3 is approximately 9.97, that of 1.2 is approximately 3.32, and that of 0.5 is approximately 1.65. The total sum of these exponentials is approximately 14.94. The normalized probabilities are computed by dividing each exponential value by the total sum. This yields a probability of approximately 0.667 for Regression, 0.222 for NewFeature, and 0.111 for UserMarkedNoise.

The label with the highest probability, in this case, Regression, is selected as the classifier's output. The associated probability value is reported as the confidence score, which in this example is approximately 0.667. This scalar value reflects the classifier's relative certainty in its prediction and is used by downstream systems to determine how the classification should be handled. For instance, a high-confidence Regression prediction may trigger automated enforcement logic, while a lower-confidence result may prompt manual review. The score may also be recorded for telemetry analysis, performance tracking, or as part of the retraining dataset. In some implementations, the system may further apply temperature scaling or calibration techniques to improve the reliability of the confidence values across varying data distributions.

At step 606, in a control decision, the system evaluates whether the predicted label is Regression and whether the associated confidence score exceeds a preconfigured enforcement threshold. This conditional step ensures that only high-confidence critical diffs trigger automated intervention.

At step 607, the structured diff is routed through standard post-classification processing. This occurs when the condition evaluated in step 606 is not met-specifically, when the predicted label is not Regression or the associated confidence score does not exceed the enforcement threshold. The standard post-classification process may include logging the classification result, updating model feedback repositories, or presenting the diff to a user interface for manual inspection.

If the conditions are satisfied, the method proceeds to step 608, where an enforcement component initiates a control response. The control response may include one or more of the following actions: blocking deployment of the affected build to production, revoking access credentials associated with staging artifacts, disabling forward promotion in CI/CD (Continuous Integration/Continuous Deployment) workflows, deactivating traffic routers for newly introduced endpoints, or isolating the candidate version from load balancers.

At step 610, the system logs the classification outcome and enforcement action in an audit repository. In parallel, a notification is transmitted to on-call engineers or operational stakeholders, detailing the triggered label, its confidence, and the nature of the enforcement.

The enforcement component is a configurable module that responds to the output of the classifier by executing machine-controlled actions aimed at preventing the deployment of unstable or regressive software changes. It serves as a technical bridge between inference and control logic, ensuring that structured diff classifications translate into real-time operational consequences.

In one example, the enforcement component may be implemented as an extension to an internal deployment manager which could be implemented on a server or hosted in a cloud. Upon receiving a Regression label with high confidence, the deployment manager automatically removes the associated candidate build from the internal package registry, preventing downstream systems from accessing or promoting that version. This response prevents the propagation of potentially regressive updates beyond the point of detection.

In another scenario, the enforcement logic may be embedded directly into a CI/CD controller. During continuous integration, if a structured diff is classified as a regression, the enforcement module immediately halts the promotion pipeline, preventing the test candidate from being advanced to production. This automatic interruption replaces the need for human triage and removes regressions from the deployment surface before they can reach users.

Enforcement mechanisms may also extend to the network layer. For example, in response to a Regression classification, the system may trigger dynamic updates to ingress controllers or load balancers, disabling traffic routing to newly introduced endpoints that are tied to the regressive behavior. This ensures that affected services are isolated in real-time, without requiring manual intervention.

The enforcement component may further integrate with authentication or access control systems. If a diff associated with a recent deployment shows regression indicators, the system may automatically revoke session tokens, disable temporary credentials issued for that deployment, or prevent new service accounts from authenticating with the affected version.

In operational contexts where rapid rollback is necessary, the enforcement component may also be configured to automatically restore a previously validated software version. When a Regression label is emitted with sufficient certainty, the system reverts the service to the last known good deployment without requiring external authorization.

Each of these examples demonstrates how classification results from the structured diff pipeline are not used merely for monitoring or visualization but are converted into direct machine-enforced policy actions. These mechanisms enhance the reliability of deployment workflows and support the position that the disclosed system is a technical control infrastructure, rather than an abstract automation of manual judgment.

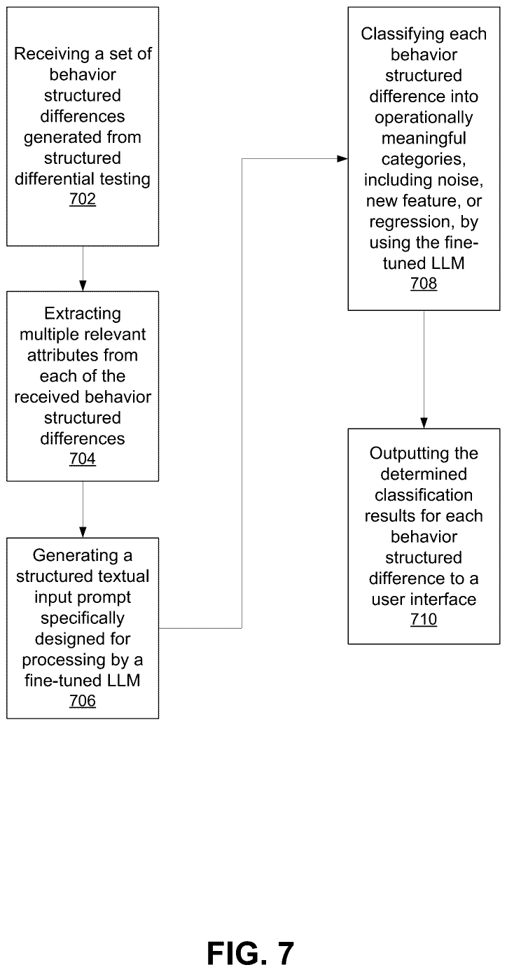

FIG. 7 illustrates a detailed flow diagram of an example computer-implemented method for classifying behavior structured differences using a fine-tuned large language model (LLM). In a first step 702, the computing system receives a set of behavior structured differences generated from structured differential testing. Each behavior structured difference represents a discrepancy identified between outputs of a test environment and outputs of a production environment when both environments process the same real-world input. These structured differences highlight behavioral deviations potentially introduced by software updates or changes.

A subsequent step 704 includes extracting multiple relevant attributes from each of the received behavior structured differences. These attributes include, at minimum, test logs that record telemetry and diagnostic information from the test environment, and production logs that capture corresponding information from the production environment. The extraction of these attributes ensures sufficient diagnostic context to enable precise and reliable classification.

In another step 706, the computing system generates a structured textual input prompt specifically designed for processing by a fine-tuned LLM. This prompt is generated by arranging the previously extracted plurality of attributes into a coherent textual sequence. The fine-tuned LLM has been adapted for this task through supervised training on historical behavior structured differences that have been previously labeled with known categories, such as noise, new feature, or regression.

In step 708, the computing system classifies each behavior structured difference into operationally meaningful categories, including noise, new feature, or regression, by using the fine-tuned LLM. The LLM analyzes patterns within the structured textual input prompt to determine the most appropriate classification. Fine-tuning ensures that the model accurately recognizes domain-specific patterns relevant to software behavior differences identified through structured differential testing.

Finally, step 710 involves outputting the determined classification results for each behavior structured difference to a user interface. Displaying these classifications to end users, such as on-call engineers, enables efficient validation of software updates and supports timely operational decision-making within release engineering workflows.

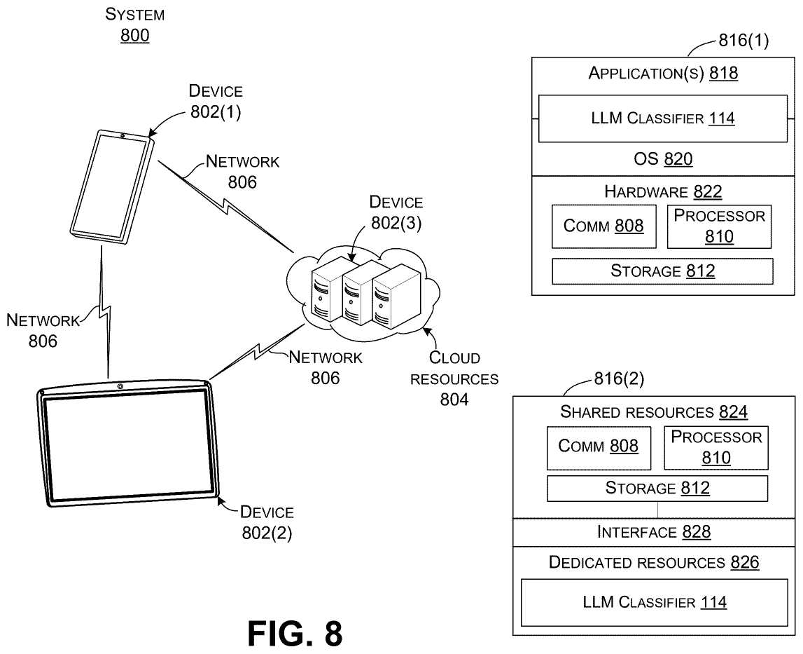

FIG. 8 shows an example system 800, all or part of which can be used to implement the various systems, modules, layers, and other computing and/or storage components disclosed herein, such as the LLC classifier 114 (also see FIG. 1). System can include computing devices 802. In the illustrated configuration, computing device 802(1) is manifest as a smartphone, computing device 802(2) is manifest as a tablet type device, and computing device 802(3) is manifest as a server type computing device, such as may be found in a datacenter as a cloud resource 804. Computing devices 802 can be coupled via one or more networks 806 that are represented by lightning bolts. Computing devices 802 can include a communication component 808, a processor 810, storage resources (e.g., storage) 812.

FIG. 8 shows two device configurations 816 that can be employed by computing devices 802. Individual computing devices 802 can employ either configuration 816(1) or 816(2), or an alternate configuration. (Due to space constraints on the drawing page, one instance of each configuration is illustrated). Briefly, device configuration 816(1) represents an operating system (OS) centric configuration. Device configuration 816(2) represents a system on a chip (SOC) configuration. Device configuration 816(1) is organized into one or more applications 818, operating system 820, and hardware 822. Device configuration 816(2) is organized into shared resources 824, dedicated resources 826, and an interface 828 therebetween.

The term “device,” “computer,” or “computing device” as used herein can mean any type of device that has some amount of processing capability and/or storage capability. Processing capability can be provided by one or more processors that can execute data in the form of computer-readable instructions to provide functionality. Data, such as computer-readable instructions and/or user-related data, can be stored on/in storage, such as storage that can be internal or external to the device. The storage can include any one or more of volatile or non-volatile memory, hard drives, flash storage devices, and/or optical storage devices (e.g., CDs, DVDs etc.), remote storage (e.g., cloud-based storage), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

As mentioned above, device configuration 816(2) can be thought of as a system on a chip (SOC) type proposal. In such a case, functionality provided by the device can be integrated on a single SOC or multiple coupled SOCs. One or more processors 810 can be configured to coordinate with shared resources 824, such as storage 812, etc., and/or one or more dedicated resources 826, such as hardware blocks configured to perform certain specific functionality. Thus, the term “processor” as used herein can also refer to central processing units (CPUs), graphical processing units (GPUs), field programable gate arrays (FPGAs), controllers, microcontrollers, processor cores, hardware processing units, or other types of processing devices.

Generally, any of the functions described herein can be implemented using software, firmware, hardware (e.g., fixed-logic circuitry), or a combination of these implementations. The term “component” as used herein generally represents software, firmware, hardware, whole devices or networks, or a combination thereof. In the case of a software implementation, for instance, these may represent program code that performs specified tasks when executed on a processor (e.g., CPU, CPUs, GPU or GPUs). The program code can be stored in one or more computer-readable memory devices, such as computer-readable storage media. The features and techniques of the components are platform-independent, meaning that they may be implemented on a variety of commercial computing platforms having a variety of processing configurations.

Artificial intelligence (AI), as applied within this invention, refers to a computational system configured to perform inference, classification, and decision-making tasks based on structured representations of observed data. The AI system operates as part of a broader computing architecture and may be implemented using one or more machine learning models trained to identify and interpret patterns in complex datasets.

In one embodiment, the AI component includes a large language model (LLM) adapted to process textual and semi-structured input data. This model may be trained or fine-tuned on domain-specific data to support accurate classification of behavior patterns and discrepancies. The AI system may include various subcomponents such as embedding generators, similarity evaluators, prompt constructors, and classification engines. These components interact to convert raw telemetry or diagnostic signals into structured inputs for analysis and to produce actionable outputs.

The AI processing system may be implemented in software, firmware, or hardware, and may execute on a variety of computing platforms including cloud-based infrastructures, local servers, or embedded processors. Input data may include logs, metadata, or other structured artifacts derived from system telemetry. Outputs may include classification labels, confidence scores, or decision triggers that inform downstream system behavior.

The use of AI in this context enables scalable, consistent, and repeatable interpretation of operational differences across software environments, replacing manual review with automated classification logic. By training on historical patterns and leveraging learned representations of system behavior, the AI system improves operational efficiency and supports continuous integration and deployment workflows in modern software engineering environments.

### Machine Learning Overview

There are various types of machine learning frameworks that can be trained to perform a given task. Support vector machines, decision trees, and neural networks are just a few examples of machine learning frameworks that have been used in a wide variety of applications, such as image processing and natural language processing. Some machine learning frameworks, such as neural networks, use layers of nodes that perform specific operations.

In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs. Various training procedures can be applied to learn the edge weights and/or bias values. The term “parameters” when used without a modifier is used herein to refer to learnable values such as edge weights and bias values that can be learned by training a machine learning model, such as a neural network.

A neural network structure can have different layers that perform different specific functions. For example, one or more layers of nodes can collectively perform a specific operation, such as pooling, encoding, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “trained model” and/or “tuned model” refers to a model structure together with parameters for the model structure that have been trained or tuned. Note that two trained models can share the same model structure and yet have different values for the parameters, e.g., if the two models are trained on different training data or if there are underlying stochastic processes in the training process.

There are many machine learning tasks for which there is a relative lack of training data. One broad approach to training a model with limited task-specific training data for a particular task involves “transfer learning.” In transfer learning, a model is first pretrained on another task for which significant training data is available, and then the model is tuned to the particular task using the task-specific training data.

The term “pretraining,” as used herein, refers to model training on a set of pretraining data to adjust model parameters in a manner that allows for subsequent tuning of those model parameters to adapt the model for one or more specific tasks. In some cases, the pretraining can involve a self-supervised learning process on unlabeled pretraining data, where a “self-supervised” learning process involves learning from the structure of pretraining examples, potentially in the absence of explicit (e.g., manually-provided) labels. Subsequent modification of model parameters obtained by pretraining is referred to herein as “tuning.” Tuning can be performed for one or more tasks using supervised learning from explicitly-labeled training data, in some cases using a different task for tuning than for pretraining.

### TERMINOLOGY

For the purposes of this document, the term “language model” refers to any type of automated agent that communicates via natural language. For instance, a language model can be implemented as a neural network, e.g., a decoder-based generative language model such as versions of ChatGPT, Gemini, Chameleon, a long short-term memory model, etc. The term “generative model,” as used herein, refers to a machine learning model employed to generate new content. Generative models can be trained to predict items in sequences of training data. When employed in inference mode, the output of a generative model can include new sequences of items that the model generates. Thus, a “generative language model” is a model that can generate new sequences of text given some input prompt, e.g., a query potentially with some additional context.

The term “prompt,” as used herein, refers to input text provided to a generative language model that the generative language model uses to generate output text. A prompt can include a query, e.g., a request for information from the generative language model. A prompt can also include context, or additional information that the generative language model uses to respond to the query.

The term “data health issue” refers to any characteristic of a dataset that could impact results of processing that dataset. Examples of data health issues include the presence of corrupted data, erroneous data, improperly formatted data, statistical outliers, etc. The term “data evaluation action” refers to any action performed on a dataset that can identify a data health issue. A “data evaluation plan” is one or more data evaluation actions that can be performed on a given dataset. A “data cleaning action” is an action that attempts to improve data quality by correcting at least one data health issue, e.g., by removing an entry or value from a dataset, changing a value in the dataset to a different value, etc.

A “summary” of a dataset refers to a representation of the dataset as a whole. A summary of a dataset can include data types of fields of the dataset, statistical information for fields of the dataset, and/or annotations of individual fields of the dataset, a set of fields of the dataset, or the dataset as a whole. A “data health score” refers to any metric that characterizes the presence of data health issues in a dataset. A “severity dictionary” is one or more indications of how severe a particular type of data health issue is when present in a dataset. For instance, a severity dictionary can indicate that missing values are relatively more severe than statistical outliers, and can include weights designating the relative severity of each.

The term “machine learning model” refers to any of a broad range of models that can learn to generate automated user input and/or application output by observing properties of past interactions between users and applications. For instance, a machine learning model could be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards. The term “user-specific model” refers to a model that has at least one component that has been trained or constructed at least partially for a specific user. Thus, this term encompasses models that have been trained entirely for a specific user, models that are initialized using multi-user data and tuned to the specific user, and models that have both generic components trained for multiple users and one or more components trained or tuned for the specific user. Likewise, the term “application-specific model” refers to a model that has at least one component that has been trained or constructed at least partially for a specific application.

The term “pruning” refers to removing parts of a machine learning model while retaining other parts of the machine learning model. For instance, a large machine learning model can be pruned to a smaller machine learning model for a specific task by retaining weights and/or nodes that significantly contribute to the ability of that model to perform a specific task, while removing other weights or nodes that do not significantly contribute to the ability of that model to perform that specific task. A large machine learning model can be distilled into a smaller machine learning model for a specific task by training the smaller machine learning model to approximate the output distribution of the large machine learning model for a task-specific dataset.

### Example Decoder-Based Language Model

An example generative language model is now described that can be employed using the disclosed implementations. This generative language model is an example of a machine learning model that can be used to perform one or more natural language processing tasks that involve generating text, as discussed more below. For the purposes of this document, the term “natural language” means language that is normally used by human beings for writing or conversation.

The generative language model can receive input text, e.g., a prompt from a user. For instance, the input text can include words, sentences, phrases, or other representations of language. The input text can be broken into tokens and mapped to token and position embeddings representing the input text. Token embeddings can be represented in a vector space where semantically-similar and/or syntactically-similar embeddings are relatively close to one another, and less semantically-similar or less syntactically-similar tokens are relatively further apart. Position embeddings represent the location of each token in order relative to the other tokens from the input text.

The token and position embeddings are processed in one or more decoder blocks. Each decoder block implements masked multi-head self-attention, which is a mechanism relating different positions of tokens within the input text to compute the similarities between those tokens. Each token embedding is represented as a weighted sum of other tokens in the input text. Attention is only applied for already-decoded values, and future values are masked. Layer normalization normalizes features to mean values of 0 and variance to 1, resulting in smooth gradients. A Feed forward layer transforms these features into a representation suitable for the next iteration of decoding, after which another layer normalization is applied. Multiple instances of decoder blocks can operate sequentially on input text, with each subsequent decoder block operating on the output of a preceding decoder block. After the final decoding block, a text prediction layer can predict the next word in the sequence, which is output as output text in response to the input text and also fed back into the language model. The output text can be a newly-generated response to the prompt provided as input text to the generative language model.

### Additional Examples

Various device examples are described above. Additional examples are described below. One example includes a computer-implemented method, comprising receiving, at a computing system, a set of behavior structured differences generated from structured differential testing, each behavior structured difference representing a discrepancy between an output of a test environment and an output of a production environment for a same real-world input, extracting, by the computing system, a plurality of attributes from each behavior structured difference, the plurality of attributes including at least test logs and production logs, generating, by the computing system, an input prompt for a large language model (LLM) by structuring the plurality of attributes into a textual sequence, classifying, using the LLM executed on the computing system, each behavior structured difference into categories including noise, new feature, or regression based on the input prompt, and outputting, by the computing system, the classification for each behavior structured difference to a user interface, wherein the classification enables validation of a software update.

Another example can include any of the above and/or below examples where the plurality of attributes further includes a description of a behavior structured difference, and calls associated with the behavior structured difference.

Another example can include any of the above and/or below examples where the plurality of attributes further includes tags identifying or categorizing the behavior structured difference, and/or comments from on-call engineers.

Another example can include any of the above and/or below examples where the method further comprises fine-tuning the LLM based on a training dataset comprising historical behavior structured differences labeled with categories, using a parameter-efficient tuning technique that inserts additional trainable matrices into selected layers of a model architecture while maintaining a portion of pretrained parameters in a fixed state.

Another example can include any of the above and/or below examples where the method further comprises dynamically identifying exemplar behavior structured differences based on semantic similarity to each received behavior structured difference, wherein the exemplar behavior structured differences are included in the input prompt provided to the large language model.

Another example can include any of the above and/or below examples where the method further comprises dynamically selecting exemplary behavior structured differences from a training dataset based on similarity to each behavior structured difference in a received set.

Another example can include any of the above and/or below examples where the exemplary behavior structured differences are included in the input prompt for the LLM.

Another example can include any of the above and/or below examples where the method further comprises assigning confidence scores to each classification, the confidence scores indicate reliability in the classification.

Another example can include any of the above and/or below examples where the confidence scores are generated based on similarity measures between classified behavior structured differences and exemplary behavior structured differences from a fine-tuning dataset.

Another example can include any of the above and/or below examples where the method further comprises prioritizing manual review of classifications having confidence scores below a predetermined threshold.

Another example can include any of the above and/or below examples where the LLM employs a Low-Rank Adaptation (LoRA) fine-tuning technique.

Another example includes a system comprising a traffic router configured to duplicate production traffic, sending identical requests to a production server and a test server, the production server configured to process production traffic requests and generate telemetry data, the test server configured to process duplicated traffic requests and generate telemetry data, a structured difference engine configured to compare telemetry data from the production server and the test server, and generate behavioral structured differences, a structured difference database configured to store the behavioral structured differences, an artificial intelligence processing module configured to classify the behavioral structured differences into noise, new feature, or regression, and an output interface configured to display classified behavioral structured differences.

Another example can include any of the above and/or below examples where the artificial intelligence processing module is configured to retrieve and structure behavioral structured differences into input prompts for an LLM.

Another example can include any of the above and/or below examples where the LLM employs a Low-Rank Adaptation (LoRA) fine-tuning technique.

Another example can include any of the above and/or below examples where the artificial intelligence processing module is configured to dynamically identify historical behavioral structured differences based on semantic similarity.

Another example can include any of the above and/or below examples where the structured difference database stores attributes including logs, call metadata, tags, and comments from on-call engineers.

Another example can include any of the above and/or below examples where the method further comprises a feedback mechanism configured to update a fine-tuning dataset based on manual classification corrections.

Another example includes a computer-implemented method, comprising receiving, by a computing system, a training dataset comprising a plurality of labeled behavior structured differences, each behavior structured difference comprising a plurality of attributes including test logs, production logs, a description, and a label selected from a predefined set of classification categories, encoding, by the computing system, the plurality of attributes for each behavior structured difference into a serialized textual format, applying, by the computing system, a parameter-efficient fine-tuning technique to a pretrained large language model, the parameter-efficient fine-tuning technique configured to update a set of inserted trainable parameters while maintaining pretrained model parameters in a fixed state, and producing, by the computing system, a large language model adapted to assign a classification category to an unlabeled behavior structured difference based on encoded attributes derived from software telemetry.

Another example can include any of the above and/or below examples where the parameter-efficient fine-tuning technique comprises inserting low-rank adaptation matrices into projection layers of the pretrained large language model, and optimizing the low-rank adaptation matrices using a supervised loss function computed over classification error.

Another example can include any of the above and/or below examples where the metho further comprises validating the large language model by applying it to a reserved subset of the training dataset and evaluating performance metrics including accuracy, precision, and recall across each classification category.

### CONCLUSION

The description includes a system and method for automated classification of behavior-structured differences in release engineering workflows using large language models, which can include fine-tuned LLMs. While the subject matter has been described with reference to specific architectural components, data preparation methods, classification techniques, model training strategies, and evaluation procedures, it is to be understood that the subject matter defined in the appended claims is not limited to the precise configurations or acts disclosed herein. Rather, the disclosed embodiments represent example implementations of the claimed subject matter, and other configurations, modifications, or equivalents that would be recognized by one of ordinary skill in the art are intended to be within the scope of the claims.

1. A computer-implemented method, comprising:
receiving, at a computing system, a set of behavior structured differences generated from structured differential testing, each behavior structured difference representing a discrepancy between an output of a test environment and an output of a production environment for a same real-world input;
extracting, by the computing system, a plurality of attributes from each behavior structured difference, the plurality of attributes including at least test logs and production logs;
generating, by the computing system, an input prompt for a large language model (LLM) by structuring the plurality of attributes into a textual sequence;
classifying, using the LLM executed on the computing system, each behavior structured difference into categories including noise, new feature, or regression based on the input prompt; and
outputting, by the computing system, the classification for each behavior structured difference to a user interface, wherein the classification enables validation of a software update.

2. The method of claim 1, wherein the plurality of attributes further includes a description of a behavior structured difference, and calls associated with the behavior structured difference.

3. The method of claim 2, wherein the plurality of attributes further includes tags identifying or categorizing the behavior structured difference, and/or comments from on-call engineers.

4. The method of claim 1, further comprising fine-tuning the LLM based on a training dataset comprising historical behavior structured differences labeled with categories, using a parameter-efficient tuning technique that inserts additional trainable matrices into selected layers of a model architecture while maintaining a portion of pretrained parameters in a fixed state.

5. The method of claim 1, further comprising dynamically identifying exemplar behavior structured differences based on semantic similarity to each received behavior structured difference, wherein the exemplar behavior structured differences are included in the input prompt provided to the large language model.

6. The method of claim 1, further comprising dynamically selecting exemplary behavior structured differences from a training dataset based on similarity to each behavior structured difference in a received set.

7. The method of claim 6, wherein the exemplary behavior structured differences are included in the input prompt for the LLM.

8. The method of claim 1, further comprising assigning confidence scores to each classification, the confidence scores indicate reliability in the classification.

9. The method of claim 8, wherein the confidence scores are generated based on similarity measures between classified behavior structured differences and exemplary behavior structured differences from a fine-tuning dataset.

10. The method of claim 9, further comprising prioritizing manual review of classifications having confidence scores below a predetermined threshold.

11. The method of claim 1, wherein the LLM employs a Low-Rank Adaptation (LoRA) fine-tuning technique.

12. A system, comprising:
a traffic router configured to duplicate production traffic, sending identical requests to a production server and a test server;
the production server configured to process production traffic requests and generate telemetry data;
the test server configured to process duplicated traffic requests and generate telemetry data;
a structured difference engine configured to compare telemetry data from the production server and the test server, and generate behavioral structured differences;
a structured difference database configured to store the behavioral structured differences;
an artificial intelligence processing module configured to classify the behavioral structured differences into noise, new feature, or regression; and
an output interface configured to display classified behavioral structured differences.

13. The system of claim 12, wherein the artificial intelligence processing module is configured to retrieve and structure behavioral structured differences into input prompts for an LLM.

14. The system of claim 13, wherein the LLM employs a Low-Rank Adaptation (LoRA) fine-tuning technique.

15. The system of claim 13, wherein the artificial intelligence processing module is configured to dynamically identify historical behavioral structured differences based on semantic similarity.

16. The system of claim 12, wherein the structured difference database stores attributes including logs, call metadata, tags, and comments from on-call engineers.

17. The system of claim 12, further comprising a feedback mechanism configured to update a fine-tuning dataset based on manual classification corrections.

18. A computer-implemented method, comprising:
receiving, by a computing system, a training dataset comprising a plurality of labeled behavior structured differences, each behavior structured difference comprising a plurality of attributes including test logs, production logs, a description, and a label selected from a predefined set of classification categories;
encoding, by the computing system, the plurality of attributes for each behavior structured difference into a serialized textual format;
applying, by the computing system, a parameter-efficient fine-tuning technique to a pretrained large language model, the parameter-efficient fine-tuning technique configured to update a set of inserted trainable parameters while maintaining pretrained model parameters in a fixed state; and
producing, by the computing system, a large language model adapted to assign a classification category to an unlabeled behavior structured difference based on encoded attributes derived from software telemetry.

19. The method of claim 18, wherein the parameter-efficient fine-tuning technique comprises inserting low-rank adaptation matrices into projection layers of the pretrained large language model, and optimizing the low-rank adaptation matrices using a supervised loss function computed over classification error.

20. The method of claim 18, further comprising validating the large language model by applying it to a reserved subset of the training dataset and evaluating performance metrics including accuracy, precision, and recall across each classification category.
